(19) United States
(12) Patent Application Publication
(10) Pub. No.: US 2026/0045116 A1
(43) Pub. Date: Feb. 12, 2026

(54) FINGERPRINT SENSOR PACKAGE AND DEVICE INCLUDING THE SAME

(71) Applicant: SAMSUNG ELECTRONICS CO., LTD., SUWON-SI, GYEONGGI-DO (KR)

(72) Inventors: Gayoung KIM, Suwon-si, Gyeonggi-do (KR); Youngjun YOON, Suwon-si, Gyeonggi-do (KR); Yechung CHUNG, Suwon-si, Gyeonggi-do (KR)

(21) Appl. No.: 18/744,766

(22) Filed: Jun. 17, 2024

(30) Foreign Application Priority Data
Oct. 6, 2023 (KR) 10-2023-0133611

(51) Int. Cl. G06V 40/13; G06F 21/32

(52) U.S. Cl. CPC G06V 40/1329; G06F 21/32

(57) ABSTRACT

A fingerprint sensor package includes: a substrate including a plurality of first sensing patterns spaced apart from each other in a first direction and extending in a second direction, intersecting the first direction, and a plurality of second sensing patterns spaced apart from each other in the second direction and extending in the first direction; a controller chip electrically connected to the substrate; an encapsulant covering the controller chip; and a plurality of electrical connection structures electrically connected to the substrate and contacting the encapsulant, wherein at least one of the plurality of electrical connection structures is exposed from the encapsulant in a direction different from a direction in which the plurality of electrical connection structures and the substrate face each other.

### CROSS-REFERENCE TO RELATED APPLICATION

This application claims priority under 35 U.S.C. § 119 to Korean Patent Application No. 10-2023-0133611 filed on Oct. 6, 2023, in the Korean Intellectual Property Office, the disclosure of which is incorporated by reference herein in its entirety.

### TECHNICAL FIELD

Example embodiments of the present inventive concept relate to a fingerprint sensor package and a device including the same.

### DISCUSSION OF THE RELATED ART

Fingerprint recognition technology is used to prevent various security incidents by recognizing a user's fingerprint and going through a registration and authentication process. For example, the technology is applied to individual and organizational network defense and provides protection for various contents and data to secure access to financial information. Generally, a fingerprint sensor acquires the user's fingerprint information by using an optical method, a capacitive method, an ultrasonic method, a thermal sensing method, or the like. The recent trend in the fingerprint sensor industry is to achieve low costs while continuously miniaturizing and thinning products. Accordingly, it is desirable to have a fingerprint sensor package with increased reliability and sensitivity of acquiring fingerprint information, a reduction in overall size and height, and reduced manufacturing costs.

### SUMMARY

According to an embodiment of the present inventive concept, a fingerprint sensor package includes: a substrate including a plurality of first sensing patterns spaced apart from each other in a first direction and extending in a second direction, intersecting the first direction, and a plurality of second sensing patterns spaced apart from each other in the second direction and extending in the first direction; a controller chip electrically connected to the substrate; an encapsulant covering the controller chip; and a plurality of electrical connection structures electrically connected to the substrate and contacting the encapsulant, wherein at least one of the plurality of electrical connection structures is exposed from the encapsulant in a direction different from a direction in which the plurality of electrical connection structures and the substrate face each other.

According to an embodiment of the present inventive concept, a fingerprint sensor package includes: a substrate including a plurality of first sensing patterns spaced apart from each other in a first direction and extending in a second direction, intersecting the first direction, and a plurality of second sensing patterns spaced apart from each other in the second direction and extending in the first direction; a controller chip electrically connected to the substrate; an encapsulant covering the controller chip; and a plurality of electrical connection structures electrically connected to the substrate and contacting the encapsulant, wherein at least one portion of the plurality of electrical connection structures extends along a surface of the encapsulant from a portion, of the plurality of electrical connection structures, that is exposed from the encapsulant.

According to an embodiment of the present inventive concept, a device includes: a device body including a recessed region; a plurality of terminals arranged in the recessed region; and a fingerprint sensor package disposed in the recessed region, wherein the fingerprint sensor package includes: a substrate including a plurality of first sensing patterns spaced apart from each other in a first direction and extending in a second direction, intersecting the first direction, and a plurality of second sensing patterns spaced apart from each other in the second direction and extending in the first direction; a controller chip electrically connected to the substrate; and a plurality of electrical connection structures electrically connected to the plurality of terminals and the substrate, wherein a direction in which the plurality of electrical connection structures and the plurality of terminals face is different from a recess direction of the recessed region.

### BRIEF DESCRIPTION OF DRAWINGS

The above and other aspects of the present inventive concept will become more apparent by describing in detail example embodiments thereof, with reference to the accompanying drawings, in which:

FIGS. 1A, 1B, 1C, 1D, and 1E are views illustrating a fingerprint sensor package according to an example embodiment of the present inventive concept;

FIGS. 2A, 2B, 2C, 2D, 2E, 2F and 2G are views illustrating a process of manufacturing a fingerprint sensor package and assembling the fingerprint sensor package to a device according to an example embodiment of the present inventive concept; and

FIGS. 3, 4, 5, 6, 7, 8, 9, 10, and 11 are cross-sectional views illustrating a fingerprint sensor package according to an example embodiment of the present inventive concept.

### DETAILED DESCRIPTION

In the following detailed description of the present inventive concept, references are made to the accompanying drawings that show, by way of illustration, example embodiments of the present inventive concept. It should be understood that various example embodiments of the present inventive concept, although different, are not necessarily mutually exclusive of each other. For example, specific features, structures, and characteristics described herein, in connection with one example embodiment, may be implemented with other example embodiments of the present inventive concept without departing from the spirit and scope of the present inventive concept. In addition, it should be understood that the location or arrangement of individual elements within each disclosed example embodiment may be modified without departing from the spirit and scope of the present inventive concept. The following detailed description is, therefore, not to be taken as limiting the present inventive concept. In the drawings and specification, similar reference numerals may refer to the same or similar elements, and thus, repetitive descriptions may be omitted or briefly discussed.

Hereinafter, example embodiments of the present inventive concept will be described in detail with reference to the accompanying drawings.

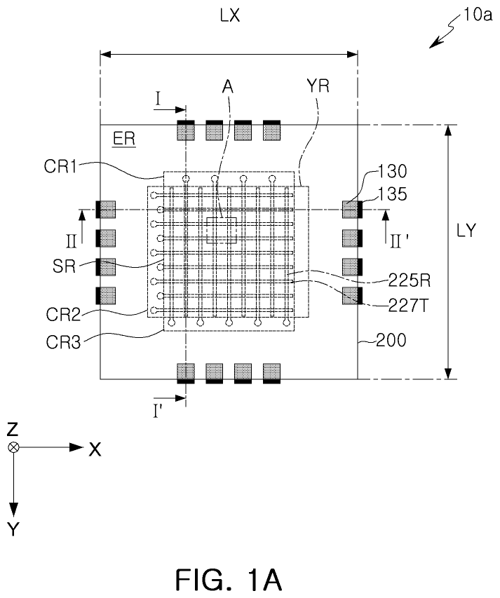

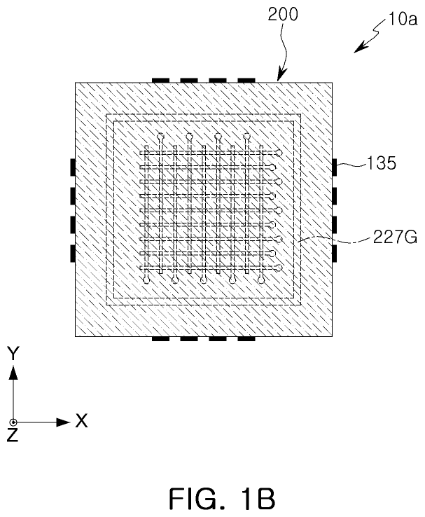

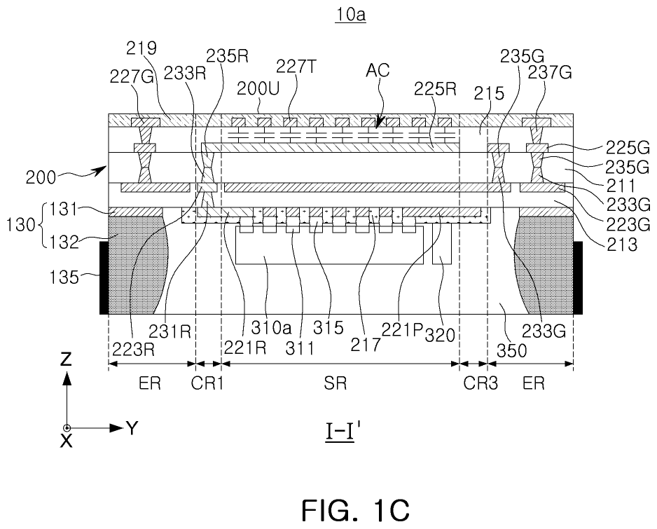

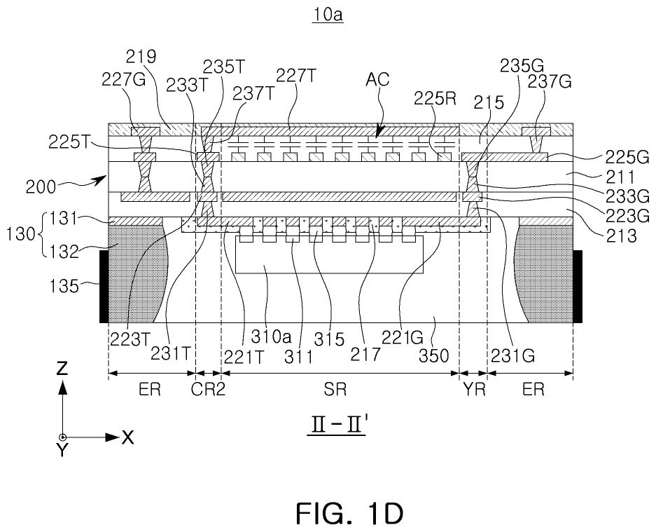

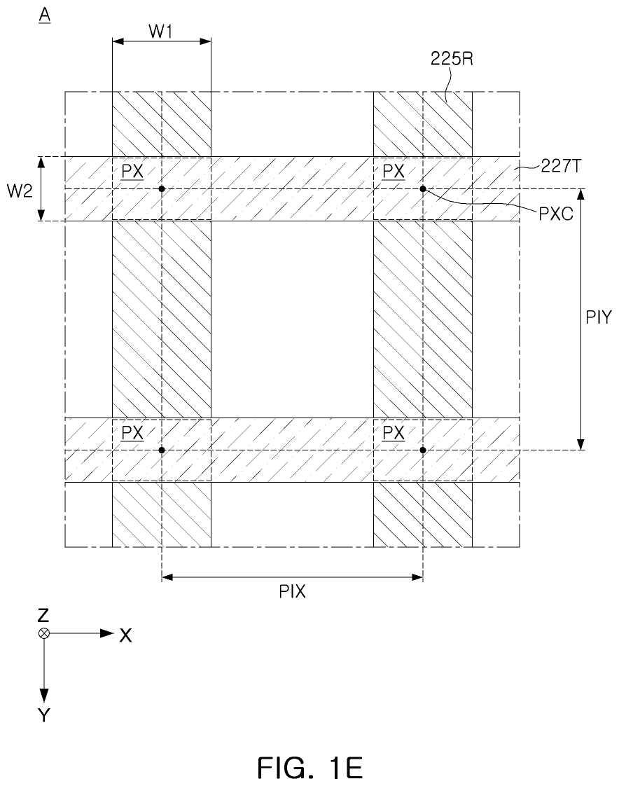

FIG. 1A is a bottom view schematically illustrating a layout of a fingerprint sensor package 10a. FIG. 1B is a plan view illustrating the fingerprint sensor package 10a of FIG. 1A. FIG. 1C is a cross-sectional view taken along line I-I′ of FIG. 1A. FIG. 1D is a cross-sectional view taken along the line II-II′ of FIG. 1A, and FIG. 1E is an enlarged view illustrating a region indicated by “A” in FIG. 1A.

Referring to FIGS. 1A to 1E, a fingerprint sensor package 10a according to an example embodiment of the present inventive concept may include a substrate 200, a controller chip 310a, an encapsulant 350, and a plurality of electrical connection structures 130. Referring to FIG. 1A, the substrate 200 may include a sensing region SR, a first contact region CR1, a second contact region CR2, a third contact region CR3, a wiring region YR, and a peripheral region ER. Referring to FIG. 1C, the substrate 200 may include a base layer 211, a lower insulating layer 213 that is disposed on a lower surface of the base layer 211, an upper insulating layer 215 that is disposed on an upper surface of the base layer 211, a lower protective layer 217 that is disposed on a lower surface of the lower insulating layer 213, and an upper protective layer 219 that is disposed on an upper surface of the upper insulating layer 215.

The substrate 200 may have a substantially rectangular planar shape or a square planar shape. The substrate 200 may include an upper surface 200U and a lower surface opposite to each other, and the upper surface 200U of the substrate 200 may be a surface for fingerprint recognition. A lower surface of the substrate 200 may be a surface on which components such as a controller chip 310a are mounted. A first length LX of the substrate 200 in a first direction (X-direction) may range from about 10 mm to about 15 mm. Furthermore, a second length LY in a second direction (Y-direction) of the substrate 200 may range from about 10 mm to about 15 mm. For example, the first length LX of the substrate 200 may be about 12.7 mm, and the second length LY may be about 12.7 mm.

The substrate 200 may include a printed circuit board (PCB). In example embodiments of the present inventive concept, the substrate 200 may include a rigid type substrate. Furthermore, the substrate 200 may be a PCB having a multilayer structure including a plurality of conductive layers. The substrate 200 may include conductive layers disposed on different vertical levels and conductive vias for electrically connecting the conductive layers to each other. For example, the conductive layers and the conductive vias may each include at least one of copper (Cu), aluminum (Al), nickel (Ni), silver (Ag), gold (Au), platinum (Pt), tin (Sn), lead (Pb), titanium (Ti), chromium (Cr), palladium (Pd), indium (In), zinc (Zn), carbon (C), and alloys thereof.

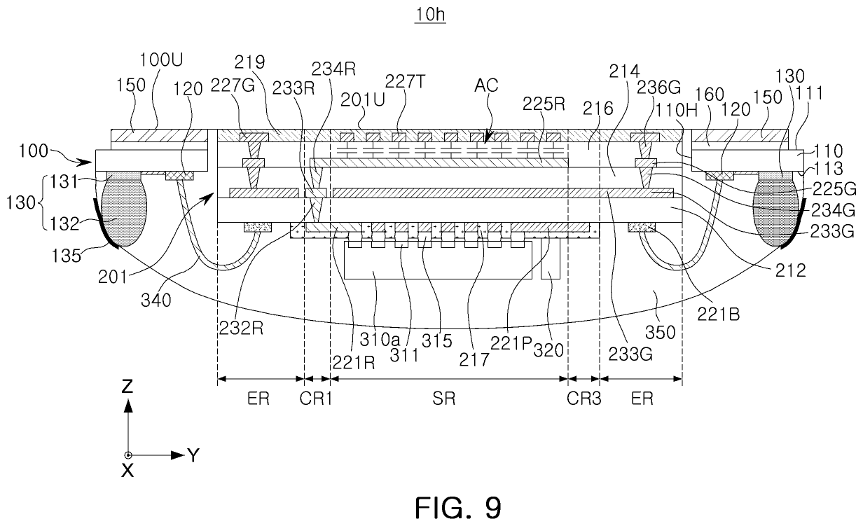

For example, the substrate 200 may include first conductive layers 221B (see, e.g., FIGS. 9 through 11), 221G, 221R, 221T and 221P, second conductive layers 223G, 223R and 223T, third conductive layers 225G, 225R and 225T, and fourth conductive layers 227G and 227T in order of decreasing distance away from the upper surface 200U. The first conductive layers 221B, 221G, 221R, 221T and 221P may be disposed on a lower surface of the lower insulating layer 213. The second conductive layers 223G, 223R and 223T may be disposed on a lower surface of the base layer 211, and the third conductive layers 225G, 225R and 225T may be disposed on an upper surface of the base layer 211. The fourth conductive layers 227G and 227T may be disposed on the upper surface of the upper insulating layer 215.

The first conductive layers 221B, 221G, 221R, 221T and 221P may include second bonding pads 221B, first-first sensing pads 221R, first-second sensing pads 221T, a first ground pattern 221G, and a power pattern 221P. The second conductive layers 223G, 223R and 223T may include second-first sensing pads 223R, second-second sensing pads 223T, and a second ground pattern 223G. The third conductive layers 225G, 225R and 225T may include first sensing patterns 225R, third-second sensing pads 225T, and a third ground pattern 225G. The fourth conductive layers 227G and 227T may include second sensing patterns 227T and a fourth ground pattern 227G.

The conductive vias 231R, 233R and 235R may be spaced apart from the ground pattern 223G and may electrically connect a plurality of first sensing patterns 225R and a plurality of second sensing patterns 227T to the controller chip 310a. The ground pattern 223G may be disposed between the lower insulating layer 213 and the base layer 211, and may overlap the controller chip 310a vertically. Accordingly, the ground pattern 223G may increase electromagnetic isolation between the first and second sensing patterns 225R and 227T and the controller chip 310a, and may reduce noise of signals of the first and second sensing patterns 225R and 227T.

Furthermore, the substrate 200 may include first conductive vias 231G, 231R and 231T for electrically connecting the first conductive layers 221B, 221G, 221R, 221T and 221P to the second conductive layers 223G, 223R and 223T. The substrate 200 may further include second conductive vias 233G, 233R and 233T and third conductive vias 235G, 235R and 235T for electrically connecting the second conductive layers 223G, 223R and 223T to the third conductive layers 225G, 225R and 225T. The substrate 200 additionally includes fourth conductive vias 237T and 237G for electrically connecting the third conductive layers 225G, 225R and 225T to the fourth conductive layers 227G and 227T. The first conductive vias 231G, 231R and 231T may at least partially penetrate through the lower insulating layer 213, and the second conductive vias 233G, 233R and 233T may partially penetrate through the base layer 211. The third conductive vias 235G, 235R and 235T may partially penetrate through the base layer 211, and the fourth conductive vias 237T and 237G may at least partially penetrate through the upper insulating layer 215.

The first conductive vias 231G, 231R and 231T may include first-first sensing vias 231R for electrically connecting the first-first sensing pads 221R and the second-first sensing pads 223R to each other, first-second sensing vias 231T for electrically connecting the first-second sensing pads 221T and the second-second sensing pads 223T to each other, a first ground via 231G for electrically connecting the first ground pattern 221G and the second ground pattern 223G to each other. In example embodiments of the present inventive concept, the first conductive vias 231G, 231R and 231T may have a tapered structure in which a horizontal width thereof decreases as the base layer 211 is approached.

The second conductive vias 233G, 233R and 233T may include second-first sensing vias 233R for electrically connecting the second-first sensing pads 223R and the first sensing patterns 225R to each other, second-second sensing vias 233T for electrically connecting the second-second sensing pads 223T and the third-second sensing pads 225T to each other, and a second ground via 233G for electrically connecting the second ground pattern 223G and the third ground pattern 225G to each other. The third conductive vias 235G, 235R, and 235T may include third-first sensing vias 235R for electrically connecting the second-first sensing pads 223R and the first sensing patterns 225R to each other, third-second sensing vias 235T for electrically connecting the second-second sensing pads 223T and the third-second sensing pads 225T to each other, and a third ground via 235G for electrically connecting the second ground pattern 223G and the third ground pattern 225G to each other.

The second conductive vias 233G, 233R and 233T may be in contact with the second conductive layers 223G, 223R and 223T, respectively. The third conductive vias 235G, 235R and 235T may be in contact with the third conductive layers 225G, 225R and 225T, respectively, and the second conductive vias 233G, 233R and 233T and the third conductive vias 235G, 235R and 235T may be in contact with each other, respectively. Specifically, the second-first sensing pads 223R and the first sensing patterns 225R may be electrically connected to each other through the second-first sensing vias 233R and the third-first sensing vias 235R which are vertically connected to each other, and the second-second sensing pads 223T and the third-second sensing pads 225T may be electrically connected to each other through the second-second sensing vias 233T and the third-second sensing vias 235T which are vertically connected to each other. The second ground pattern 223G and the third ground pattern 225G may be electrically connected to each other through the second ground via 233G and the third ground via 235G which are vertically connected to each other.

In example embodiments of the present inventive concept, each of the second conductive vias 233G, 233R and 233T and the third conductive vias 235G, 235R and 235T may have a tapered structure in which a horizontal width thereof decreases as a center of the base layer 211 is approached in a thickness direction. In example embodiments of the present inventive concept, the second conductive vias 233G, 233R and 233T and the third conductive vias 235G, 235R and 235T may have a minimum horizontal width on a contact surface therebetween.

The fourth conductive vias 237T and 237G may have fourth-second sensing vias 237T for electrically connecting the third-second sensing pads 225T and the second sensing patterns 227T to each other, and a fourth ground via 237G for electrically connecting the third ground pattern 225G and the fourth ground pattern 227G to each other. In example embodiments of the present inventive concept, the fourth conductive vias 237T and 237G may have a tapered structure in which a horizontal width thereof decreases as the base layer 211 is approached in a thickness direction.

Referring to FIG. 1A, the substrate 200 may include a sensing region SR, a first contact region CR1, a second contact region CR2, a third contact region CR3, a wiring region YR, and a peripheral region ER. For example, the sensing region SR may be a region in which the first and second sensing patterns 225R and 227T for fingerprint recognition are disposed. Referring to FIG. 1C, the first contact region CR1 and the third contact region CR3 may be a region in which the first-first sensing vias 231R, the second-first sensing vias 233R, and the third-first sensing vias 235R for connecting the first sensing patterns 225R and the controller chip 310a to each other are disposed. Referring to FIG. 1D, the second contact region CR2 may be a region in which the first-second sensing vias 231T, the second-second sensing vias 233T, the third-second sensing vias 235T, and the fourth-second sensing vias 237T for connecting the second sensing patterns 227T and the controller chip 310a to each other are disposed. The wiring region YR may be a region in which at least some of the first to fourth ground vias 231G, 233G, 235G and 237G for connecting the fourth ground pattern 227G and the controller chip 310a to each other are disposed.

Referring to FIGS. 1A and 1E, the sensing region SR may be disposed in a central portion of the substrate 200. In example embodiments of the present inventive concept, the sensing region SR may have a rectangular or square shape when viewed in plan view. A plurality of line-shaped first sensing patterns 225R, which are spaced apart from each other in a first direction (X-direction) and extending in a second direction (Y-direction), are disposed in the sensing region SR. In addition, a plurality of line-shaped second sensing patterns 227T, which are spaced apart from each other in the second direction (Y-direction) and extending in the first direction (X-direction), are disposed in the sensing region SR.

A first contact region CR1 may be formed at one end of the sensing region SR in the second direction (Y-direction), and a third contact region CR3 may be formed at another end of the sensing region SR in the second direction (Y direction). For example, the first contact region CR1 and the third contact region CR3 may be respectively disposed at opposite ends of the sensing region SR. Furthermore, a second contact region CR2 may be formed in one end of the sensing region SR in the first direction (X-direction), and a wiring region YR may be formed in another end of the sensing region SR in the first direction (X-direction). For example, the second contact region CR2 and the wiring region YR may be respectively disposed at opposite ends of the sensing region SR.

The peripheral region ER may be disposed in an outer portion of the substrate 200. The peripheral region ER may surround the sensing region SR, the first through third contact regions CR1, CR2, and CR3, and the wiring region YR, when viewed in a plan view. Second bonding pads 221B (see, e.g., FIGS. 9 through 11) may be disposed in the peripheral region ER. First to fourth ground patterns 221G, 223G, 225G and 227G for providing reference potential and shielding sensing noise may be disposed in the peripheral region ER.

The first sensing patterns 225R may extend between the sensing region SR and the first contact region CR1 or between the sensing region SR and the third contact region CR3. The first sensing patterns 225R may be connected to the controller chip 310a through the first-first sensing vias 231R, the second-first sensing vias 233R, and the third-first sensing vias 235R that are disposed in the first and third contact regions CR1 and CR3. In the first contact region CR1, each of the first-first sensing vias 231R, the second-first sensing vias 233R, and the third-first sensing vias 235R may be arranged in the first direction (X-direction). Furthermore, in the third contact region CR3, each of the first-first sensing vias 231R, the second-first sensing vias 233R, and the third-first sensing vias 235R may be arranged in the first direction (X-direction). Some of the first sensing patterns 225R may be connected to the first-first sensing vias 231R, the second-first sensing vias 233R, and the third-first sensing vias 235R that are disposed in the first contact region CR1. Furthermore, others of the first sensing patterns 225R may be connected to the first-first sensing vias 231R, the second-first sensing vias 233R, and the third-first sensing vias 235R that are disposed in the third contact region CR3. Neighboring first sensing patterns 225R may be electrically separated from each other.

The second sensing patterns 227T may extend in the sensing region SR and the second contact region CR2. The second sensing patterns 227T may be connected to the controller chip 310a through the first-second sensing vias 231T, the second-second sensing vias 233T, the third-second sensing vias 235T, and the fourth-second sensing vias 237T that are disposed in the second contact region CR2. Each of the first-second sensing vias 231T, the second-second sensing vias 233T, the third-second sensing vias 235T, and the fourth-second sensing vias 237T may be alternately arranged in a zigzag in the second direction (Y-direction). For example, the first-second sensing vias 231T, the second-second sensing vias 233T, the third-second sensing vias 235T, and the fourth-second sensing vias 237T may have an alternating arrangement along the second direction (Y-direction).

The first sensing patterns 225R may have a first width W1 in the first direction (X-direction), and the second sensing patterns 227T may have a second width W2 in the second direction (Y-direction). In example embodiments of the present inventive concept, the first width W1 may be greater than the second width W2. For example, the first width W1 may have a range from about 2 to about 4 times a range of the second width W2. For example, the first width W1 may range from about 40 μm to about 70 μm, and the second width W2 may range from about 5 μm to about 25 μm.

A portion in which the first sensing patterns 225R and the second sensing patterns 227T overlap each other in a third direction (Z-direction) may constitute pixels PX. A first pitch PIX in the first direction (X-direction) between centers PXC of the pixels PX may be substantially identical to a second pitch PIY in the second direction (Y-direction) between the centers PXC of the pixels PX, but the present inventive concept is not limited thereto. For example, each of the first pitch PIX and the second pitch PY may range from about 50 μm to about 90 μm.

The pixels PX may have a combined capacitance value based on area capacitance AC, which is based on the first sensing patterns 225R and the second sensing patterns 227T overlapping each other, and fringing capacitance, which is based on the first sensing patterns 225R and the second sensing patterns 227T.

When a user's fingerprint comes into contact with the upper surface 200U of the substrate 200, a capacitance value corresponding to each of the pixels PX is changed by the capacitance induced between the second sensing patterns 227T and the user's fingerprint. Since the change in the capacitance value is determined by a shape of the user's fingerprint, the controller chip 310a may identify the user's fingerprint from a change in capacitance values of the pixels PX.

The fourth ground pattern 227G may surround the sensing region SR, in which the second sensing patterns 227T are disposed, in a plan view. The fourth ground pattern 227G may be disposed on substantially the same vertical level as that of the second sensing patterns 227T. Thus, the fourth ground pattern 227G surrounds the second sensing patterns 227T in a plan view. For example, the fourth ground pattern 227G may extend continuously along an edge of the sensing region SR on the upper surface of the upper insulating layer 215, and thus, the fourth ground pattern 227G surrounds the second sensing patterns 227T in a plan view. The fourth ground pattern 227G may be disposed around the sensing region SR and may function to reduce sensing noise while the user's fingerprint is in contact with the sensing region SR.

The base layer 211 may include an insulating material. The base layer 211 may include a resin and glass fibers. For example, the resin included in the base layer 211 may include at least one of a phenol resin, an epoxy resin, and/or polyimide. In example embodiments of the present inventive concept, the base layer 211 may include at least one of Flame Retardant 4 (FR4), tetrafunctional epoxy, polyphenylene ether, epoxy/polyphenylene oxide, Thermount, bismaleimide triazine (BT), cyanate ester, polyimide, Prepreg, an Ajinomoto build-up film (ABF), and/or liquid crystal polymer. In example embodiments of the present inventive concept, the base layer 211 may include silicon oxide, silicon nitride, silicon oxynitride, or combinations thereof. The glass fiber included in the base layer 211 is a reinforcing material, and may be obtained through a concentrated treatment of a glass filament obtained by melt spinning a glass material at high temperature. The glass filament may be a processed ore product containing silica as a main component.

Hereinafter, for convenience of explanation and understanding, components of the substrate 200 will be described in an order close to the base layer 211.

The second conductive layers 223G, 223R and 223T may include second-first sensing pads 223R, second-second sensing pads 223T, and a second ground pattern 223G to which a reference potential is applied. The second ground pattern 223G may be disposed in the sensing region SR, the wiring region YR, and the peripheral region ER. A portion of the second ground pattern 223G may overlap the first sensing patterns 225R and the second sensing patterns 227T in the third direction (Z-direction). A portion of the second ground pattern 223G may be interposed between the second sensing patterns 227T and the controller chip 310a. Accordingly, the second ground pattern 223G may block external sensing noise from the controller chip 310a. The second-first sensing pads 223R may be disposed in the first and third contact regions CR1 and CR3, and the second-second sensing pads 223T may be disposed in the second contact region CR2. The second-first sensing pads 223R may provide a path for an electrical connection between the first sensing patterns 225R and the controller chip 310a, and the second-second sensing pads 223T may provide a path for an electrical connection between the second sensing patterns 227T and the controller chip 310a.

The lower insulating layer 213 may be disposed on a lower surface of the base layer 211 and may cover the second conductive layers 223G, 223R and 223T. The lower insulating layer 213 may electrically separate the second-first sensing pads 223R, the second-second sensing pads 223T, and the second ground pattern 223G from each other.

The third conductive layers 225G, 225R and 225T may include a third ground pattern 225G to which the reference potential is applied, first sensing patterns 225R for recognizing the user's fingerprint, and third-second sensing pads 225T. The first sensing patterns 225R may be disposed in the sensing region SR, and the third ground pattern 225G may be disposed in the wiring region YR and the peripheral region ER. The third-second sensing pads 225T may be disposed in the second contact region CR2. The third-second sensing pads 225T may provide a path for an electrical connection between the second sensing patterns 227T and the controller chip 310a.

The upper insulation layer 215 may be disposed on an upper surface of the base layer 211 and may cover the third conductive layers 225G, 225R and 225T. The upper insulating layer 215 may electrically separate the first sensing patterns 225R, the third-second sensing pads 225T, and the third ground pattern 223G from each other.

The lower insulating layer 213 and the upper insulating layer 215 may include different materials from each other. For example, the upper insulating layer 215 may include a material having a dielectric constant suitable for fingerprint recognition of the fingerprint sensor package 10. However, the present inventive concept is not limited thereto, and the lower insulating layer 213 and the upper insulating layer 215 may include the same material as each other.

Each of the lower insulating layer 213 and the upper insulating layer 215 may include at least one of, for example, a phenol resin, an epoxy resin, and/or polyimide. In example embodiments of the present inventive concept, each of the lower insulating layer 213 and the upper insulating layer 215 may include at least one of Prepreg, FR4, Tetrafunctional epoxy, Polyphenylene ether, Epoxy/polyphenylene oxide, Thermount, BT, Cyanate ester, polyimide, and/or liquid crystal polymer.

The fourth conductive layers 227G and 227T may be disposed on the upper surface of the upper insulating layer 215. The fourth conductive layers 227G and 227T may include a fourth ground pattern 227G for removing sensing noise and second sensing patterns 227T for recognizing the user's fingerprint. The second sensing patterns 227T may be disposed in the sensing region SR, and the fourth ground pattern 227G may be disposed in the peripheral region ER.

The second sensing patterns 227T may be spaced apart from the first sensing patterns 225R in the third direction (Z-direction) with the insulating layer 215 interposed therebetween. For example, the second sensing patterns 227T may be electrically insulated from the first sensing patterns 225R by the upper insulating layer 215. Accordingly, the first sensing patterns 225R may form a first electrode of a capacitor, and the upper insulating layer 215 may form a dielectric layer of the capacitor. In addition, the second sensing patterns 227T may form a second electrode of the capacitor. For example, capacitors forming the fingerprint sensor may be formed in the substrate 200.

The upper protective layer 219 may be disposed on an upper surface of the upper insulation layer 215 and may cover the fourth conductive layers 227G and 227T.

The first conductive layers 221B, 221G, 221R, 221T and 221P may be disposed on a lower surface of the lower insulating layer 213. The first conductive layers 221B, 221G, 221R, 221T and 221P may include second bonding pads 221B, first-first sensing pads 221R, first-second sensing pads 221T and a first ground pattern 221G to which the reference potential is applied.

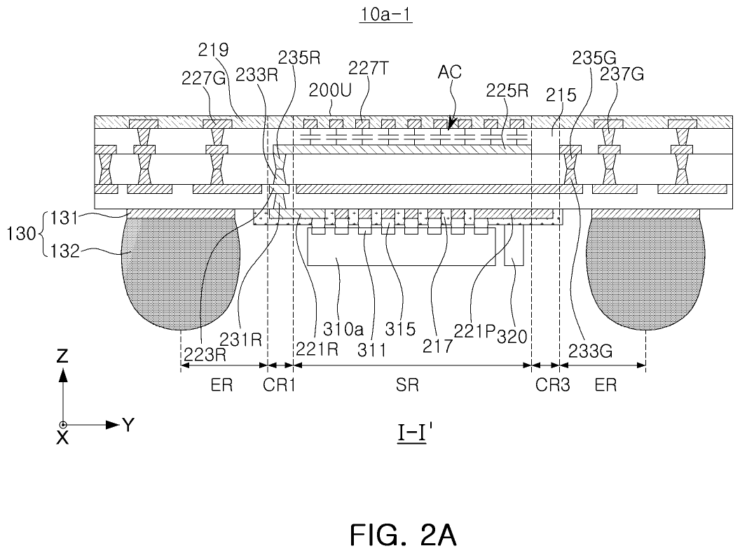

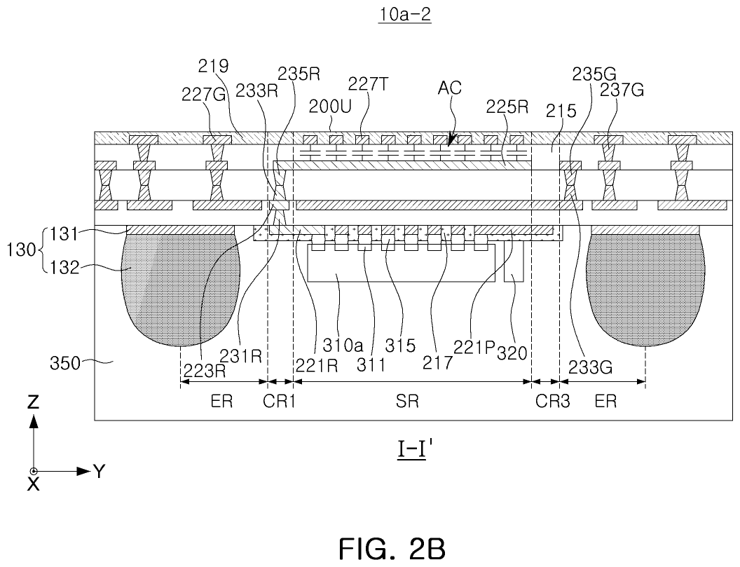

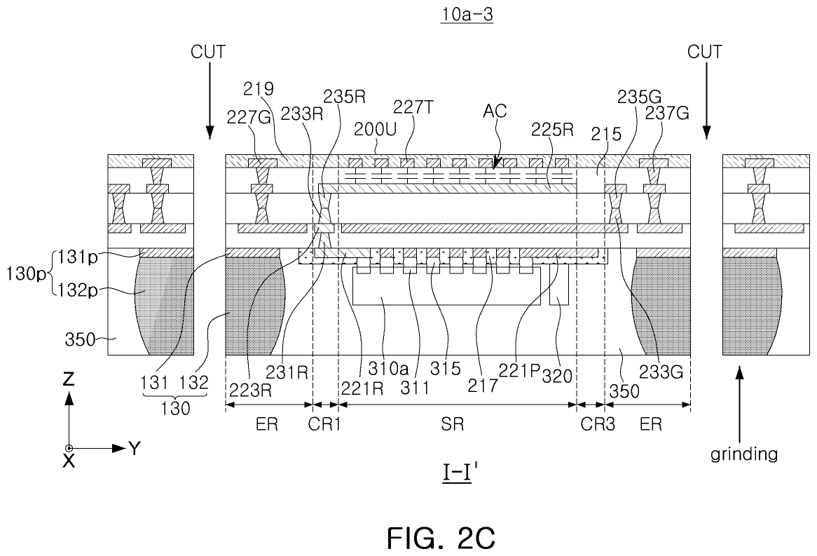

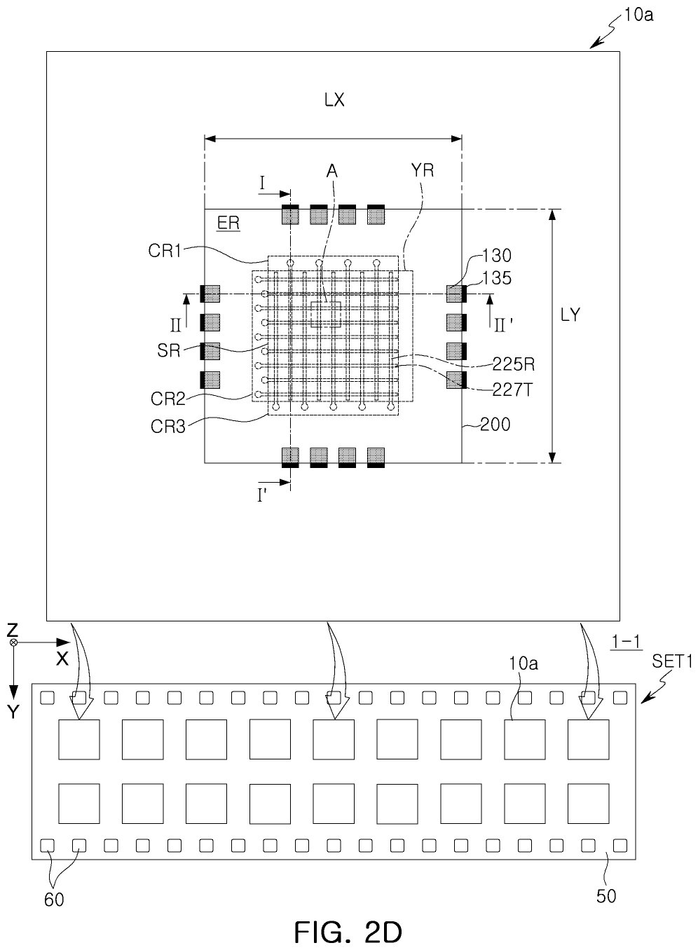

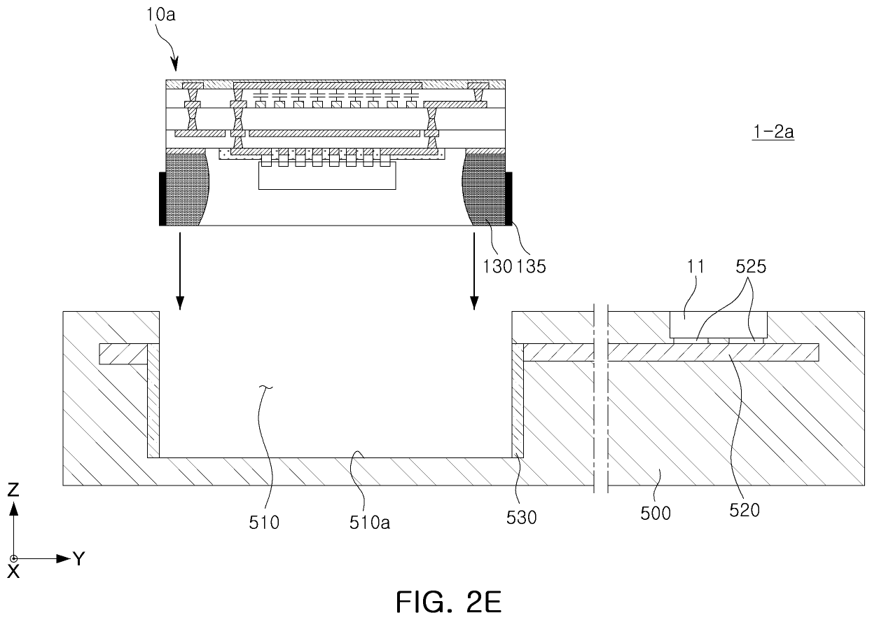

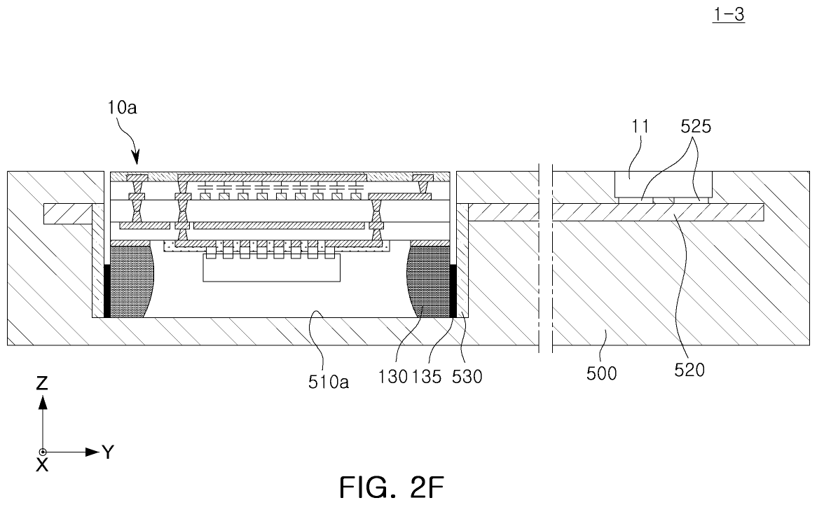

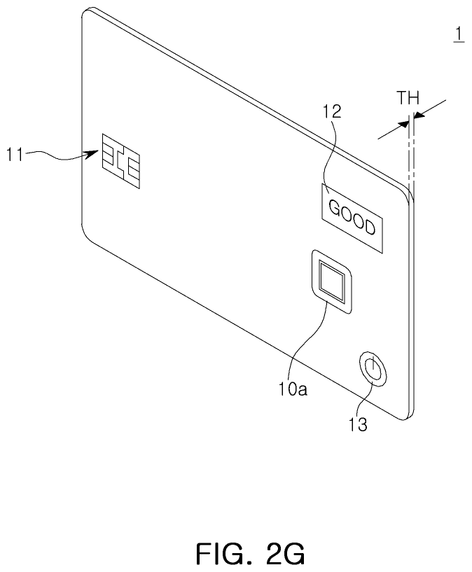

With reference to FIGS. 9 through 11, the second bonding pads 221B may be connected to conductive wires 340, and may be electrically connected to first bonding pads 120 of an edge substrate 100 through the conductive wires 340. The second bonding pads 221B may include a power pad to which power (e.g., power potential) supplied from an external device is applied, a ground pad to which the reference potential is applied, and an output pad for outputting fingerprint recognition results of the fingerprint sensor package 10 to the outside (for example, a display unit 12 of the device 1 of FIG. 2G). The controller chip 310a may receive a power potential through some of the second bonding pads 221B and the power pattern 221P, and may receive the reference potential through some of the second bonding pads 221B and the first ground pattern 221G. Furthermore, the controller chip 310a may receive a signal recognized from the first and second sensing patterns 225R and 227T through the first-first sensing pads 221R and the first-second sensing pads 221T.

The first-first sensing pads 221R may extend from the first and third contact regions CR1 and CR3 to a portion overlapping the controller chip 310a in the third direction (Z-direction), and the first-second sensing pads 221T may extend from the second contact region CR2 to a portion overlapping the controller chip 310a in the third direction (Z-direction). The first-first sensing pads 221R may provide a path for an electrical connection between the first sensing patterns 225R and the controller chip 310a, and the first-second sensing pads 221T may provide a path for an electrical connection between the second sensing patterns 227T and the controller chip 310a.

The lower protective layer 217 may be disposed on a lower surface of the lower insulating layer 213 to cover at least a portion of the first conductive layers 221B, 221G, 221R, 221T and 221P. However, the present inventive concept is not limited thereto, and for example, the lower protective layer 217 might not cover the second bonding pad 221B. In example embodiments of the present inventive concept, the lower protective layer 217 may be formed to cover a partial region of the lower surface of the lower insulating layer 213. In example embodiments of the present inventive concept, the lower protective layer 217 may be formed to entirely cover the lower surface of the lower insulating layer 213.

Each of the lower protective layer 217 and the upper protective layer 219 may be an insulating coating layer. In example embodiments of the present inventive concept, the lower protective layer 217 and the upper protective layer 219 may be formed of solder resist. In example embodiments of the present inventive concept, the lower protective layer 217 and the upper protective layer 219 may include a polymer material having excellent heat resistance, excellent insulation, and excellent hardness. For example, each of the lower protective layer 217 and the upper protective layer 219 may be formed of polyimide, polyamide, polyacetal, polycarbonate, and the like. According to example embodiments of the present inventive concept, the upper protective layer 219 in contact with the user's fingerprint may be formed of a material having a higher hardness than that of the lower protective layer 217 to protect against external influences such as contamination, impact, and scratch. For example, the upper protective layer 219 and the lower protective layer 217 may be formed of solder resist, and the upper protective layer 219 may be formed of high hardness solder resist having a hardness of 4H or more. In example embodiments of the present inventive concept, the upper protective layer 219 may include a material (e.g., a high dielectric material) having a dielectric constant suitable for recognizing a fingerprint.

The controller chip 310a may be electrically connected to the substrate 200. The controller chip 310a and a passive element 320 may be disposed on a lower surface of the substrate 200. The controller chip 310a may be mounted on the lower surface of the substrate 200 in a flip chip manner. Connection bumps 315 may electrically and physically connect the controller chip 310a and the substrate 200 to each other, and may be disposed between the controller chip 310a and the substrate 200. The connection bumps 315 may be disposed between some patterns of the first conductive layers 221B, 221G, 221R, 221T and 221P and chip pads 311 of the controller chip 310a.

In example embodiments of the present inventive concept, the controller chip 310a may be entirely or partially disposed in the sensing region SR. In example embodiments of the present inventive concept, the controller chip 310a may be disposed outside the sensing region SR as a whole. Like a memory chip and/or a processor chip, the controller chip 310a may include any configuration for performing an operation for recognizing the user's fingerprint from a change in capacitance values of the pixels PX. Furthermore, the passive element 320 may include, for example, a multilayer ceramic capacitor (MLCC), but the present inventive concept is not limited thereto.

The encapsulant 350 may encapsulate the controller chip 310a. The encapsulant 350 may be disposed on the substrate 200 and may cover the controller chip 310a and the passive element 320. The encapsulant 350 may serve to protect the substrate 200, the controller chip 310a, and the passive element 320 from external influences such as contamination and impacts. The encapsulant 350 may be formed of an epoxy molding compound. In addition, the encapsulant 350 may be formed of an epoxy-based material, a thermosetting material, a thermoplastic material, a UV treatment material, or the like.

Since the sensing region SR corresponding to the fingerprint recognition sensor is included in the substrate 200, the fingerprint sensor package 10a according to an example embodiments of the present inventive concept may reduce an overall thickness, and may be used to manufacture smart cards having a thickness equal to that of conventional credit cards and check cards. Furthermore, in the fingerprint sensor package 10a according to an example embodiment of the present inventive concept, the sensing region SR of the substrate 200 may be exposed to the outside to come into direct contact with the user's fingerprint, thereby increasing reliability and sensitivity of acquiring fingerprint information.

The fingerprint sensor package 10a according to an example embodiment of the present inventive concept may have a total thickness of about 0.76 mm or less. In example embodiments of the present inventive concept, a total thickness of the fingerprint sensor package 10a may be about 0.5 mm or less. For example, the total thickness of the fingerprint sensor package 10a may range from about 0.1 mm to about 0.4 mm. Accordingly, the fingerprint sensor package 10a may be easily applied to various products (e.g., smart cards) that are bent or require a thin thickness.

A plurality of electrical connection structures 130 may be electrically connected to the substrate 200 and may contact the encapsulant 350. The plurality of electrical connection structures 130 may provide electrical connection paths between the fingerprint sensor package 10a and a device, and may be electrically connected to the controller chip 310a through the substrate 200. Accordingly, the controller chip 310a may transmit the acquired fingerprint information to the device through the plurality of electrical connection structures 130.

At least one of the plurality of electrical connection structures 130 may be exposed from the encapsulant 350 in a direction (e.g., X-direction and/or Y-direction) different from a direction (e.g., Z-direction) in which the plurality of electrical connection structures 130 and the substrate 200 face each other. Accordingly, at least one of the plurality of electrical connection structures 130 may provide electrical connection paths between the fingerprint sensor package 10a and the device in a direction (e.g., X-direction and/or Y-direction) different from a direction (e.g., Z-direction) in which the plurality of electrical connection structures 130 and the substrate 200 face each other, thereby further increasing connection/arrangement efficiency between the fingerprint sensor package 10a and the device. By increasing the connection/deployment efficiency, the fingerprint sensor package 10a and/or device may have a higher degree of design freedom or may be further miniaturized. For example, the fingerprint sensor package 10a may reduce a horizontal size of the substrate 200, and the device may be implemented to be thinner.

The fingerprint sensor package 10a may further include an anisotropic conductive film 135 that is in contact with a surface of at least one of the plurality of electrical connection structures 130 that is not covered by the encapsulant 350. The anisotropic conductive film 135 may have adhesive properties, and the plurality of electrical connection structures 130 may be attached to a plurality of terminals of the device through the anisotropic conductive film 135. Here, the plurality of terminals and the plurality of electrical connection structures 130 may be disposed adjacently to each other, and may thus be electrically connected through the anisotropic conductive film 135. In addition, since a separation distance between the plurality of electrical connection structures 130 may be relatively long, the anisotropic conductive film 135 may provide insulation between the plurality of electrical connection structures 130. Accordingly, electrical connection path characteristics of the anisotropic conductive film 135 may be anisotropic. For example, the anisotropic conductive film 135 may have a structure in which conductive particles having a diameter of about 3 μm or more and about 15 μm or less are dispersed in an adhesive polymer.

For example, the plurality of electrical connection structures 130 may be arranged to surround the controller chip 310a, and a height of at least one of the plurality of electrical connection structures 130 may be longer than a thickness of the controller chip 310a. Here, the height of each of the plurality of electrical connection structures 130 may be measured as a longest length of each of the plurality of electrical connection structures 130 in the Z-direction, and the thickness of the controller chip 310a may be measured as an average value. As the height of the plurality of electrical connection structures 130 increases, surface area of the plurality of electrical connection structures 130 that are exposed may increase, and the stability of providing electrical connection paths of the plurality of electrical connection structures 130 may be further increased.

For example, at least a portion of each of the plurality of electrical connection structures 130 may have a melting point lower than a melting point of each of the plurality of first and second sensing patterns 225R and 227T. For example, the plurality of electrical connection structures 130 may include a pad 131, which is disposed on the substrate 200, and a solder 132, which is disposed on the pad 131, and the solder 132 may have a melting point lower than the melting points of each of the first and second sensing patterns 225R and 227T and the pad 131. The pad 131 may include at least one of the conductive materials that the patterns of the substrate 200 may include. The solder 132 may include, for example, a conductive material having a low melting point, such as lead (Pb), bismuth (Bi), tin (Sn), or tin alloy (Sn—Ag—Cu). At a temperature higher than the melting point of the material of the solder 132, the solder 132 may be in a fluid state by a reflow process or a thermal compression bonding (TCB) process. Thereafter, with a decrease in the temperature, the solder 132 may be connected and fixed to the pad 131. The size and/or height of the plurality of electrical connection structures 130 may be adjusted by an adjustment of the amount of the solder 132.

FIGS. 2A to 2C illustrate a process of manufacturing a fingerprint sensor package according to an example embodiment of the present inventive concept, and FIGS. 2D to 2G illustrate a process of assembling the fingerprint sensor package according to an example embodiment of the present inventive concept into a device 1.

Referring to FIG. 2A, in each of a plurality of electrical connection structures 130 of a fingerprint sensor package 10a-1 in a first operation, one side portion (e.g., a portion biased from the center in a +Y direction) and the other side portion (e.g., a portion biased from the center in a −Y direction) may be formed in a substantially symmetrical shape. Referring to FIG. 2B, a fingerprint sensor package 10a-2 in a second operation may have a structure in which an encapsulant 350 is further formed.

Referring to FIG. 2C, a fingerprint sensor package 10a-3 in a third operation may have a form in which a portion of an encapsulant 350 is polished in a +Z direction. Here, a portion of each of the plurality of electrical connection structures 130 may also be polished. In addition, the fingerprint sensor package 10a-3 in the third operation may be cut in the Z-direction by a cutting process (CUT). Accordingly, cut portions 130p, 131p and 132p of the plurality of electrical connection structures 130 may deviate from the fingerprint sensor package 10a-3 in the third operation.

By the cutting process (CUT), one side portion (e.g., a part biased from the center in the +Y direction) and the other side portion (e.g., a portion biased from the center in the −Y direction) of the at least one of the plurality of electrical connection structures 130 (e.g., each of exposed electrical connection structures) may be asymmetrical to each other. Since a portion of the substrate 200 may also be cut by the cutting process (CUT), a surface of at least one of the plurality of electrical connection structures 130, which is exposed from the encapsulant 350, may form a coplanar surface with one side surface of the substrate 200. Then, the anisotropic conductive film 135 illustrated in FIG. 1C may be disposed on at least a portion of the coplanar surface.

Referring to FIG. 2D, a fingerprint sensor package carrier SET1 may have a structure in which a plurality of fingerprint sensor packages 10a are arranged on a film member 50. The film member 50 may have a shape in which a plurality of through-holes 60 are arranged on two sides (e.g., a Y-direction side) of the film member 50, respectively. Accordingly, the film member 50 may be efficiently provided to an infra that assembles each of the plurality of fingerprint sensor packages 10a to corresponding devices in a Reel to Reel method. For example, sawteeth of a sprocket included in the infra may be inserted into the plurality of through-holes 60, and the sprocket may rotate to wind or release the film member 50. The size, shape, density, and arrangement direction of the plurality of through-holes 60 may vary, according to the sprocket. For example, an area of each of the plurality of through-holes 60 may be smaller than an area of an upper surface of each of the substrates 200, and a shape of each of the plurality of through-holes 60 may be a circle or a polygon (including a polygon with chamfered corners). The plurality of through-holes 60 may be sprocket holes, but the present inventive concept is not limited thereto. The plurality of fingerprint sensor packages 10a may be separated from the film member 50 when used.

Referring to FIGS. 2E and 2F, the fingerprint sensor package 10a may be inserted and disposed into a recessed region 510 of devices 1-2a and 1-3. The devices 1-2a and 1-3 may include a device body 500 having the recessed region 510 and a plurality of terminals 530 that are disposed in the recessed region 510.

After the fingerprint sensor package 10a is disposed on the device 1-3, a direction (e.g., X-direction and/or Y-direction) in which the plurality of electrical connection structures 130 and the plurality of terminals 530 face may be different from a recess direction (e.g., Z direction) of the recessed region 510. For example, the plurality of connection structures 130 may face the plurality of terminals 530 in a direction (e.g., X-direction and/or Y-direction). Accordingly, since the plurality of electrical connection structures 130 may provide electrical connection paths between the fingerprint sensor package 10a and the device body 500 in a direction (e.g., X-direction and/or Y-direction) that is different from the recess direction (e.g., Z-direction) of the recessed region 510, a connection/arrangement efficiency between the fingerprint sensor package 10a and the device body 500 may be increased. By increasing the connection/deployment efficiency, the fingerprint sensor package 10a and/or the device 1-3 may have a higher degree of design freedom and/or may be further miniaturized. For example, the fingerprint sensor package 10a may reduce the horizontal size of the substrate 200, and the device 1-3 may be implemented to be thinner.

Since the fingerprint sensor package 10a may have a substantially hexahedral shape, the recessed region 510 may also have a substantially hexahedral shape. Since a side surface of the recessed region 510 that is in the shape of a hexahedron may be in a one-step form, the side surface of the recessed region 510 may have a more simplified form than a case of a two-step form. Accordingly, the degree of design freedom of the device 1-3 may be increased.

Referring to FIGS. 2E and 2F, the device 1-3 may further include at least one of a plurality of terminals 530, a device substrate 520, bumps 525, and a security chip 11.

The plurality of terminals 530 may be disposed on a side surface of the recessed region 510, and may be electrically connected to the device substrate 520. For example, the plurality of terminals 530 may be implemented in an inlay method. The device substrate 520 may be implemented as a flexible printed circuit board, and the security chip 11 may be mounted on the device substrate 520 through the bumps 525. The security chip 11 may be electrically connected to the device substrate 520 through the bumps 525. Accordingly, the security chip 11 may be electrically connected to the fingerprint sensor package 10a through the plurality of terminals 530 that is electrically connected to the device substrate 520. The security chip 11 may store financial information and may be exposed by an upper surface of the device body 500.

Referring to FIG. 2G, the device 1 may include a fingerprint sensor package 10a, a security chip 11, a display unit 12, and a power button 13. The device 1 may be a smart card, but the present inventive concept is not limited thereto. For example, the device 1 may be configured to be draped or be planted on users of the device 1, such as a wearable electronic device, and may be configured to be mounted in an electronic device (e.g., a vehicle, and a portable terminal) larger than the device 1. When the user brings his/her fingerprint into contact with the fingerprint sensor package 10 of the device 1, the device 1 may recognize the contacted fingerprint. When the recognized fingerprint matches the registered fingerprint, the security chip 11 may grant payment authority to the user of the device 1.

The smart card, which may be a type of device 1, may further include information displayed on a conventional credit card or check card, such as a card number identification unit, an expiration period identification unit, a user name, and the like. According to example embodiments of the present inventive concept, the device 1 may further include an RF chip.

The fingerprint sensor package 10 may recognize the contacted fingerprint when the user brings his or her fingerprint into contact with the fingerprint sensor. The fingerprint sensor package 10 may compare the recognized fingerprint with the registered fingerprint and determine whether the recognized fingerprint matches the registered fingerprint. The fingerprint sensor package 10 may operate after the device 1 switches to an on state.

The security chip 11 may store encrypted financial information. When the recognized fingerprint matches the registered fingerprint match, the security chip 11 may grant payment authority to the user of the device 1. For example, device 1 may allow the security chip 11 to grant the payment authority to the user based on the recognition results of the fingerprint sensor package 10, thereby preventing financial incidents caused by theft or loss.

The display unit 12 may display whether the recognized fingerprint and the registered fingerprint match, on/off status, and the like. For example, the display unit 12 may display letters, numbers, special symbols, and the like, and in some cases, the display unit 12 may further include a light emitting unit. However, the display unit 12 may be omitted depending on the type of the device 1.

The power button 13 may turn on/off the device 1. The device 1 in an off state may be switched to an on state by an operation of the power button 13, and the device 1 in the on state may be switched to the off state by the operation of the power button 13. Furthermore, when a set time elapses after the device 1 is switched to the on state, the device 1 may be automatically switched off. However, the power button 13 may be omitted depending on the type of device 1.

In example embodiments of the present inventive concept, a thickness TH of the device 1 may range from about 0.5 mm to about 1 mm. Furthermore, a thickness TH of the device 1 may be about 0.84 mm or less in accordance with international standards. For example, the thickness TH of the device 1 may be about 0.76 mm or less.

A smart card, which may be a type of device 1, may include a fingerprint sensor package 10 and have a thickness equal to that of conventional credit cards and check cards, thereby providing a high level of security to the user while maintaining the method used in the conventional credit cards or check cards.

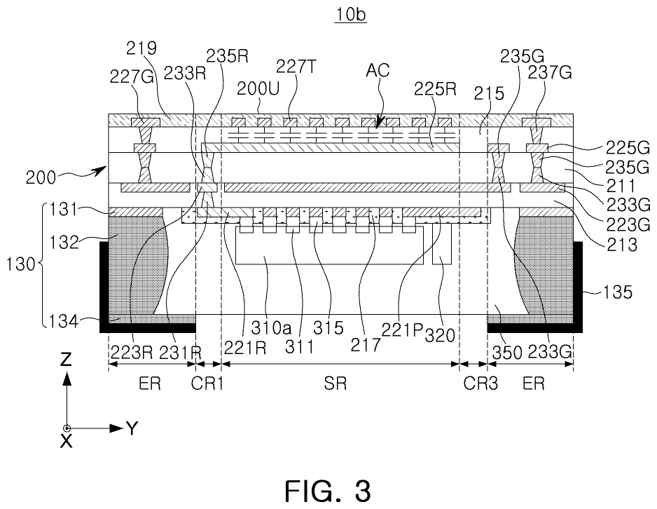

Fingerprint sensor packages 10b, 10c, 10d, 10e and 10g illustrated in FIGS. 3 to 8 may be substantially the same as or similar to the fingerprint sensor package 10a described with reference to FIGS. 1A to 1E, except for the plurality of electrical connection structures 130 and the anisotropic conductive film 135. Hereinafter, the fingerprint sensor packages 10b, 10c, 10d, 10e and 10g of FIGS. 3 to 8 will be described, focusing on differences from the fingerprint sensor package 10a described with reference to FIGS. 1A to 1E.

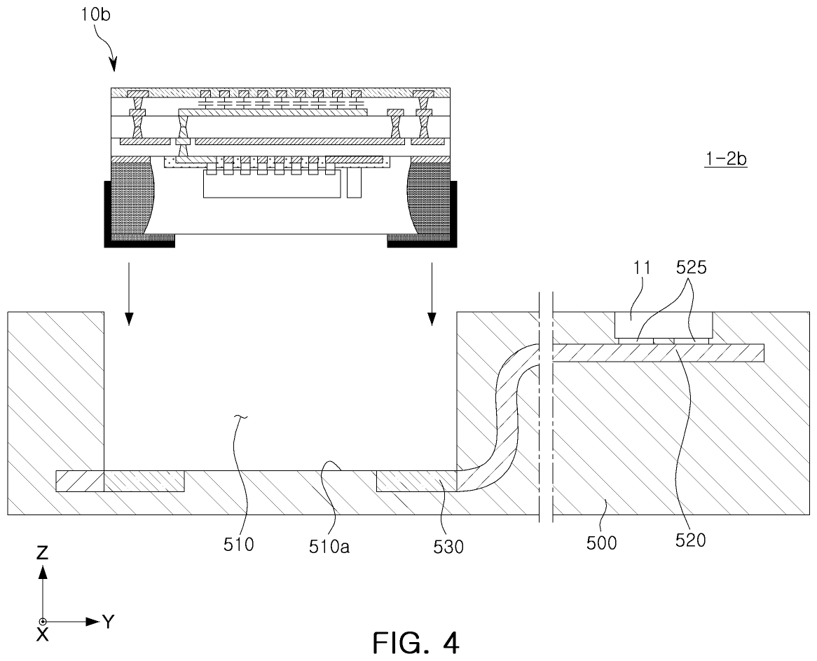

Referring to FIGS. 3 and 4, at least one portion 134 of a plurality of electrical connection structures 130 of the fingerprint sensor package 10b according to example embodiments of the present inventive concept may extend along a surface of an encapsulant 350. For example, the plurality of electrical connection structures 130 may extend along a side surface of the encapsulant 350 and a bottom surface of the encapsulant 350. Accordingly, even if there is a fine mismatch between the plurality of terminals 530 of a device 1-2b and the plurality of electrical connection structures 130, the portion 134 of the plurality of electrical connection structures 130 may be stably electrically connected to a plurality of terminals 530.

Furthermore, the degree of design freedom of the recessed region 510 or the plurality of terminals 530 of the device 1-2b may be further increased. For example, the plurality of terminals 530 may be disposed on a lower surface 510a of the recessed region 510, and the plurality of electrical connection structures 130 and the plurality of terminals 530 may be connected to each other in the Z-direction. For example, the plurality of electrical connection structures 130 of the fingerprint sensor package 10b may be implemented to cover all candidate positions of the plurality of terminals 530 when the arrangement position of the plurality of terminals 530 is not determined.

For example, one portion 134 of the plurality of electrical connection structures 130 may be formed by a plating process or may be formed by applying a conductive paste after forming the encapsulant 350. One portion 134 of the plurality of electrical connection structures 130 may include at least one of metal materials that may be included in a pad 131 and a solder 132.

The anisotropic conductive film 135 may be in contact with and disposed on one portion 134 of the plurality of electrical connection structures 130 as well as the solder 132. The anisotropic conductive film 135 may cover a portion of a side surface and a portion of a lower surface of the fingerprint sensor package 10b together, and may cover corners of the fingerprint sensor package 10b. For example, the anisotropic conductive film 135 may have a bent shape, such as an L shape.

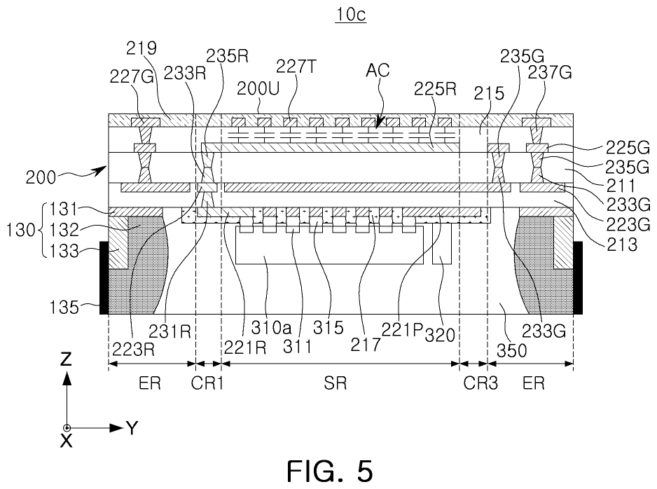

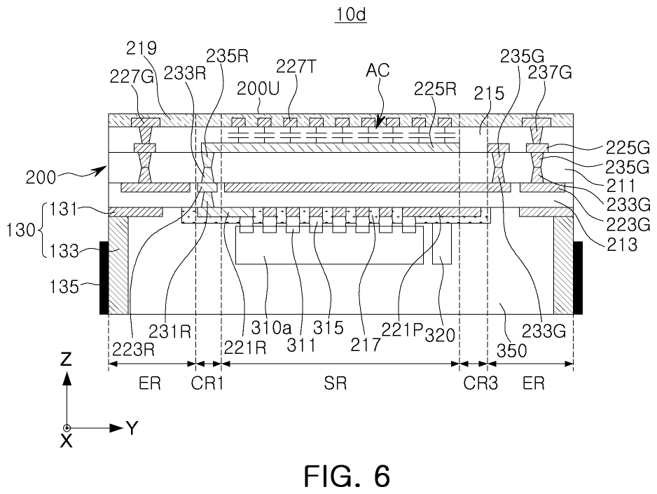

Referring to FIGS. 5 and 6, a plurality of electrical connection structures 130 of the fingerprint sensor packages 10c and 10d according to an example embodiment of the present inventive concept may include a conductive post 133. The conductive post 133 may protrude from one surface of the pad 131 in a direction away from the substrate 200 (e.g., −Z direction). For example, the conductive post 133 may be formed by forming a photoresist layer on a lower surface of a substrate 200, forming through-holes in the photoresist layer, filling the through-holes with conductive materials (e.g., copper), and removing the photoresist layer.

A portion of the conductive post 133 may be cut by the cutting process CUT illustrated in FIG. 2C. Accordingly, a side surface of the substrate 200 may be coplanar with a side surface of the conductive post 133. Since a height of the conductive post 133 may be longer than a width of the conductive post 133, the conductive post 133 may make the height of the plurality of electrical connection structures 130 longer.

Since the plurality of electrical connection structures 130 of the fingerprint sensor package 10c of FIG. 5 may include both the conductive post 133 and the solder 132, the conductive post 133 may be connected between the pad 131 and the solder 132. Since the solder 132 may at least partially surround the conductive post 133, the conductive post 133 may be a core of the solder 132. For example, depending on a design, the conductive post 133 may be implemented in a circular shape (or a truncated circle) or an elliptical shape (or a truncated elliptical shape) that is surrounded by the solder 132.

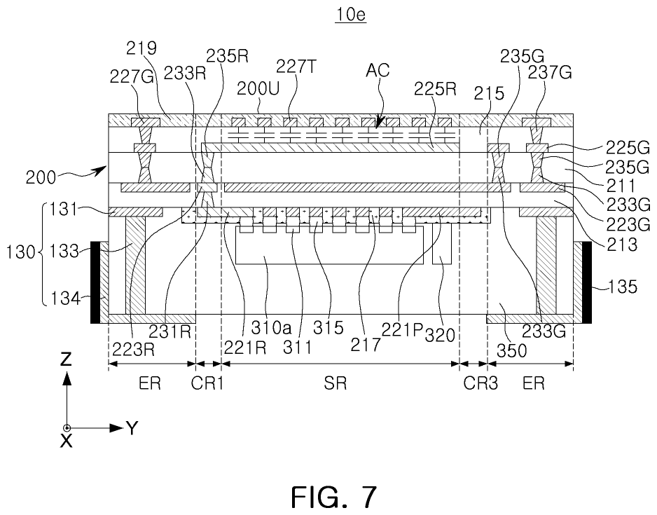

Referring to FIGS. 6 and 7, a plurality of electrical connection structures 130 of the fingerprint sensor packages 10d and 10e according to an example embodiment of the present inventive concept may include a conductive post 133 penetrating through an encapsulant 350. A conductive post 133 of FIG. 6 may be exposed by a side surface of the encapsulant 350, but a conductive post 133 of FIG. 7 may be exposed by a lower surface of the encapsulant 350.

Referring to FIG. 7, one portion 134 of a plurality of electrical connection structures 130 of the fingerprint sensor package 10e according to an example embodiment of the present inventive concept may extend from an exposed surface of the conductive post 133 and may extend along the lower surface and the side surface of the encapsulant 350. One portion 134, which extends along a surface of the encapsulant 350, of the plurality of electrical connection structures 130 may cover a portion of the lower surface and a portion of the side surface of the encapsulant 350. Accordingly, the plurality of electrical connection structures 130 may form electrical connection paths through a side surface of the fingerprint sensor package 10e.

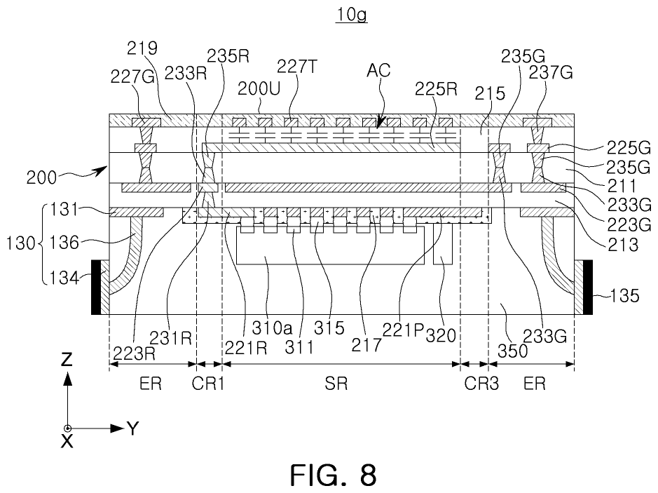

Referring to FIG. 8, a conductive post 136 of a plurality of electrical connection structures 130 of the fingerprint sensor package 10g according to an example embodiment of the present inventive concept may extend from a pad 131 in the −Z direction and may be bent in the Y-direction. For example, the conductive post 136 may be formed by a wire by a wire bonding method before forming an encapsulant 350, and forming the encapsulant 350 and then cutting a portion of the wire by the cutting process (CUT) of FIG. 2C. For example, the conductive post 136 may be curved. Accordingly, the conductive post 136 may have a form in which a portion of the wire realized by the wire bonding method is cut. To increase an exposure area of the conductive post 136, one portion 134 of the plurality of electrical connection structures 130 may extend from the conductive post 136 along the surface of the encapsulant 350. For example, the portion 134 may be disposed on an end of the conductive post 136 and a sides surface of the encapsulant 350.

Fingerprint sensor packages 10h, 10i, and 10j illustrated in FIGS. 9 to 11 may be substantially the same as or similar to the fingerprint sensor package 10a described with reference to FIGS. 1A to 1E, except for, for example, a plurality of electrical connection structures 130, an anisotropic conductive film 135, an edge substrate 100, and conductive wires 340. Hereinafter, the fingerprint sensor packages 10h, 10i, and 10j of FIGS. 9 to 11 will be described, focusing on differences from the fingerprint sensor package 10a described with reference to FIGS. 1A to 1E. Repetitive descriptions may be omitted or briefly discussed.

Referring to FIGS. 9 to 11, a plurality of electrical connection structures 130 may be exposed through a lower side surface of the encapsulant 350, and the fingerprint sensor packages 10h, 10i and 10j may further include an edge substrate 100 and a plurality of conductive wires 340.

The edge substrate 100 may be spaced apart from a substrate 201, and the plurality of conductive wires 340 may electrically connect the edge substrate 100 and the substrate 201 to each other. The plurality of electrical connection structures 130 may be disposed on the edge substrate 100 may be electrically connected to the substrate 201 through the plurality of conductive wires 340. The substrate 201 may be accommodated in a surrounding space 110H of the edge substrate 100.

An upper surface 201U of the substrate 201 may be disposed to be substantially coplanar with an upper surface 100U of the edge substrate 100. Accordingly, when the user's fingerprint comes into contact with the upper surface 100U of the edge substrate 100, the user's fingerprint may be naturally connected to a ground bezel 150 of the edge substrate 100. However, according to an example embodiment of the present inventive concept, an upper surface of the substrate 201 may be disposed to have a higher or lower level than an upper surface 100U of the edge substrate 100.

The encapsulant 350 may fill a space between a sidewall of the surrounding space 110H and a sidewall of the substrate 201. An upper surface of the encapsulant 350 may be formed to be substantially coplanar with an upper surface 100U of the edge substrate 100 and an upper surface 201U of the substrate 201. However, the present inventive concept is not limited to thereto, and according to an example embodiment of the present inventive concept, an upper surface of the encapsulant 350 may be formed to be concave by a meniscus that is generated during a manufacturing process. The encapsulant 350 may have a central portion that is thicker than an edge portion thereof. In other words, a lower surface of the encapsulant 350 may be formed to be convex.

The edge substrate 100 may include a core insulating layer 110, first bonding pads 120, external connection pads 130, a ground bezel 150, and an adhesive layer 160. The edge substrate 100 may include a printed circuit board (PCB). In example embodiments of the present inventive concept, the edge substrate 100 may include a flexible PCB (FPCB) having flexibility to be bendable. In example embodiments of the present inventive concept, the edge substrate 100 may include a rigid type PCB.

The core insulating layer 110 may have a substantially rectangular planar shape or a square planar shape, and may be provided in the form of a flexible film or plate. The core insulating layer 110 may include a first surface 111 and a second surface 113 that are opposite to each other. Here, a direction in parallel with a pair of edges of the core insulating layer 110 may be defined as a first direction (X-direction), and a direction in parallel with the other pair of edges may be defined as the second direction (Y-direction). In addition, a direction, perpendicular to a main surface (the first surface 111 or the second surface 113) of the core insulating layer 110, may be defined as a third direction (Z-direction).

The core insulating layer 110 may include an insulating material. For example, the core insulating layer 110 may be a flexible film including polyimide. For example, the core insulation layer 110 may be formed of an epoxy resin or a synthetic resin such as acrylic, polyether nitrile, polyether sulfone, polyethylene terephthalate, or polyethylene naphthalate, or the like.

The first bonding pads 120 may be disposed around the surrounding space 110H, and may be disposed on the second surface 113 of the core insulating layer 110. For example, the first bonding pads 120 may be arranged along at least one of edges of the surrounding space 110H of the core insulating layer 110. The first bonding pads 120 may be connected to the conductive wires 340 and may be electrically connected to the second bonding pads 221B of the substrate 201 through the conductive wires 340. For example, the first bonding pads 120 and the external connection pads 130 may include at least one of copper (Cu), aluminum (Al), nickel (Ni), silver (Ag), gold (Au), platinum (Pt), tin (Sn), lead (Pb), titanium (Ti), chromium (Cr), palladium (Pd), indium (In), zinc (Zn), carbon (C), and alloys thereof.

The ground bezel 150 may be disposed on the first surface 111 of the core insulating layer 110 and may be disposed around the surrounding space 110H. When the surrounding space 110H is formed in a substantially central portion of the first surface 111 of the core insulating layer 110, the ground bezel 150 may be disposed at an outer portion of the first surface 111 of the core insulating layer 110. The ground bezel 150 may be disposed around the surrounding space 110H to reduce sensing noise while the user's fingerprint is in contact with the upper surface 201U of the substrate 201 accommodated in the surrounding space 110H. For example, the ground bezel 150 may include a conductive material, for example, a metal such as copper (Cu) or aluminum (Al).

The ground bezel 150 may be electrically grounded. In example embodiments of the present inventive concept, the ground bezel 150 may be configured to receive a reference potential through a conductive via penetrating through the core insulating layer 110 and the adhesive layer 160. The conductive via may be configured to electrically connect the ground bezel 150 to an external connection pad 130, and may be used as an electrical path for transmitting the reference potential to the ground bezel 150.

The ground bezel 150 may extend along a circumference of the surrounding space 110H. The ground bezel 150 may have an annular shape surrounding the surrounding space 110H in a plan view. In example embodiments of the present inventive concept, the ground bezel 150 may be arranged to have a substantially coplanar surface with the sidewall of the surrounding space 110H. Furthermore, in example embodiments of the present inventive concept, the ground bezel 150 may be spaced apart from the surrounding space 110H.

Referring to FIG. 9, the substrate 201 of the fingerprint sensor package 10h might not include a base layer. The substrate 201 may include first to third insulating layers 212, 214 and 216, and each of the first to third insulating layers 212, 214 and 216 may include an insulating material. The substrate 201 may include first conductive vias 232R in the first insulating layer 212, second conductive vias 234G and 234R in the second insulating layer 214, third conductive vias 236G in the third insulating layer 216. The first conductive vias 232R, the second conductive vias 234G and 234R, and the third conductive vias 236G may have a tapered structure. For example, the tapered structure may have a decreasing width as a lower surface of the substrate 201 is approached.

The first insulating layer 212 may be disposed on the lower protective layer 217. The first conductive vias 232R may be in contact with the first conductive layers 221B, 221R and 221P, which are disposed on a lower surface of the first insulating layer 212, and the second conductive layers 233G and 233R, which are disposed on an upper surface of the first insulating layer 212, by penetrating through the first insulating layer 212.

The second insulating layer 214 may be disposed on the first insulating layer 212. The second conductive layers 233G and 233R may be covered with the second insulating layer 214. The second conductive vias 234G and 234R may be in contact with the second conductive layers 233G and 233R, which are disposed on the upper surface of the first insulating layer 212, and the third conductive layers 225G and 225R, which are disposed on an upper surface of the second insulating layer 214, by penetrating at least a portion of the second insulating layer 214.

The third insulating layer 216 may be disposed on the second insulating layer 214. The third conductive layers 225G and 225R may be covered with the third insulating layer 216. The third conductive vias 236G may be in contact with the third conductive layers 225G and 225R, which are disposed on the upper surface of the second insulating layer 214, and the fourth conductive layers 227G and 227T, which are disposed on an upper surface of the third insulating layer 216 by penetrating through at least a portion of the third insulating layer 216.

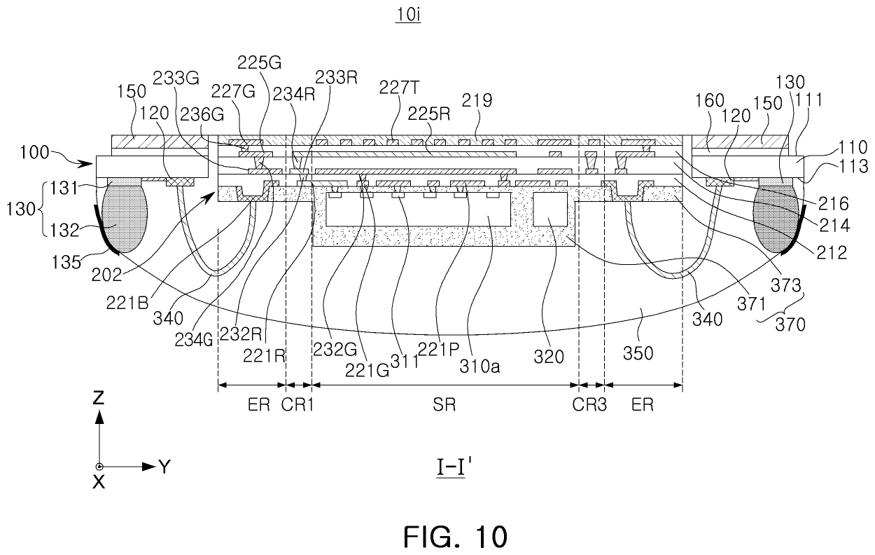

Referring to FIG. 10, a fingerprint sensor package 10i may have a fan-out wafer level package (FO-WLP) structure.

The substrate 202 might not include a base layer. The substrate 202 may include first to third insulating layers 212, 214 and 216 sequentially stacked, and a wiring structure. The wiring structure may include first conductive layers 221B, 221G, 221P and 221R, second conductive layers 233G and 233R, third conductive layers 225G and 225R, and fourth conductive layers 227G and 227T. Furthermore, the wiring structure may include first conductive vias 232G and 232R, second conductive vias 234G and 234R, and third conductive vias 236G, which have a structure tapered shape. In example embodiments of the present inventive concept, the wiring structure may be formed by a dual damascene process.

A second molding layer 370 may include a step portion that is formed by partially removing a flat mold material layer. The second molding layer 370 may include a first molding portion 371, which protects the controller chip 310a and the passive element 320, and a second molding portion 373, which surrounds the first molding portion 371. The second molding portion 373 may extend along the lower surface of the first insulating layer 212.

The second bonding pad 221B may be exposed through the second molding portion 373. For example, the second bonding pad 221B may be disposed in an opening that is formed in the second molding portion 373. A first segment of the second bonding pad 221B may extend on an upper surface of the second molding portion 373 and may be in contact with the first insulating layer 212. A second segment of the second bonding pad 221B may extend along an internal wall of the second molding portion 373 which defines the opening that is formed in the second molding portion 373, and a third segment of the second bonding pad 221B may extend on the same level as a lower surface of the second molding portion 373. The conductive wire 340 may be connected to the third segment of the second bonding pad 221B.

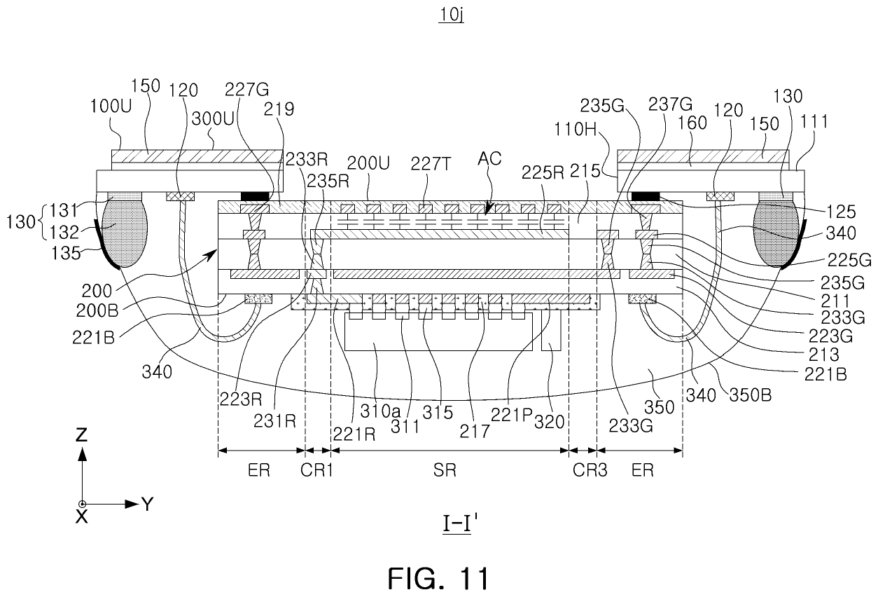

Referring to FIG. 11, a portion of an edge substrate 100 of a fingerprint sensor package 10j may vertically overlap the substrate 200. An edge adhesive portion 125 may be bonded between the edge substrate 100 and the substrate 200. For example, the edge adhesive portion 125 may be implemented similarly to the anisotropic conductive film 135 to have both adhesiveness and conductivity, and may have an annular shape or have a polygonal shape or circular shape that is arranged to surround the surrounding space 110H.

A fingerprint sensor package according to an example embodiment of the present inventive concept may increase connection efficiency to a device, and a device according to an example embodiment of the present inventive concept may increase arrangement efficiency of the fingerprint sensor package. By increasing the connection/arrangement efficiency, the fingerprint sensor package and the device including the same according to an example embodiment of the present inventive concept may have a higher degree of freedom of design and/or may be further miniaturized.

While the present inventive concept has been described with reference to embodiments thereof, it will be understood by those of ordinary skill in the art that various changes in form and details may be made thereto without departing from the spirit and scope of the present inventive concept.

What is claimed is:

1. A fingerprint sensor package comprising:
a substrate including a plurality of first sensing patterns spaced apart from each other in a first direction and extending in a second direction, intersecting the first direction, and a plurality of second sensing patterns spaced apart from each other in the second direction and extending in the first direction;
a controller chip electrically connected to the substrate;
an encapsulant covering the controller chip; and
a plurality of electrical connection structures electrically connected to the substrate and contacting the encapsulant,
wherein at least one of the plurality of electrical connection structures is exposed from the encapsulant in a direction different from a direction in which the plurality of electrical connection structures and the substrate face each other.

2. The fingerprint sensor package of claim 1, wherein one side portion and another side portion of the at least one of the plurality of electrical connection structures are asymmetrical to each other.

3. The fingerprint sensor package of claim 2, wherein a surface, of the at least one of the plurality of electrical connection structures, that is exposed from the encapsulant forms a coplanar surface with one side surface of the substrate.

4. The fingerprint sensor package of claim 3, further comprising:
an anisotropic conductive film disposed on at least a portion of the coplanar surface.

5. The fingerprint sensor package of claim 1, further comprising:
an anisotropic conductive film contacting a surface of the at least one of the plurality of electrical connection structures that is exposed from the encapsulant.

6. The fingerprint sensor package of claim 1, wherein at least a portion of each of the plurality of electrical connection structures has a melting point lower than a melting point of each of the plurality of first and second sensing patterns.

7. The fingerprint sensor package of claim 6, wherein each of the plurality of electrical connection structures comprises:
a pad disposed on the substrate; and
a solder disposed on the pad and having a melting point lower than a melting point of the pad.

8. The fingerprint sensor package of claim 7, wherein each of the plurality of electrical connection structures further comprises:
a conductive post extending from one surface of the pad in a direction away from the substrate and connected between the pad and the solder.

9. The fingerprint sensor package of claim 1, wherein each of the plurality of electrical connection structures comprises:
a pad disposed on the substrate; and
a conductive post extending from one surface of the pad in a direction away from the substrate.

10. The fingerprint sensor package of claim 1, wherein a height of the at least one of the plurality of electrical connection structures is larger than a thickness of the controller chip.

11. The fingerprint sensor package of claim 1, wherein the plurality of electrical connection structures are arranged to at least partially surround the controller chip.

12. The fingerprint sensor package of claim 11, wherein the substrate comprises:
an upper insulating layer disposed between the plurality of first sensing patterns and the plurality of second sensing patterns;
a base layer disposed between the upper insulating layer and the controller chip;
a lower insulating layer disposed between the base layer and the controller chip;
a ground pattern disposed between the lower insulating layer and the base layer and configured to overlap the controller chip vertically; and
conductive vias spaced apart from the ground pattern and electrically connecting the plurality of first sensing patterns and the plurality of second sensing patterns to the controller chip.

13. The fingerprint sensor package of claim 1, further comprising:
an edge substrate spaced apart from the substrate; and
a plurality of conductive wires electrically connecting the edge substrate and the substrate to each other,
wherein the plurality of electrical connection structures are disposed on the edge substrate and are electrically connected to the substrate through the plurality of conductive wires.

14. The fingerprint sensor package of claim 1, wherein at least one portion of the plurality of electrical connection structures extends along a surface of the encapsulant.

15. A fingerprint sensor package comprising:
a substrate including a plurality of first sensing patterns spaced apart from each other in a first direction and extending in a second direction, intersecting the first direction, and a plurality of second sensing patterns spaced apart from each other in the second direction and extending in the first direction;
a controller chip electrically connected to the substrate;
an encapsulant covering the controller chip; and
a plurality of electrical connection structures electrically connected to the substrate and contacting the encapsulant,
wherein at least one portion of the plurality of electrical connection structures extends along a surface of the encapsulant from a portion, of the plurality of electrical connection structures, that is exposed from the encapsulant.

16. The fingerprint sensor package of claim 15, further comprising:
an anisotropic conductive film disposed on the at least one portion, of the plurality of electrical connection structures, and extending along a surface of the encapsulant.

17. The fingerprint sensor package of claim 15, wherein the least one portion of the plurality of electrical connection structures covers a portion of a lower surface of the encapsulant.

18. A device comprising:
a device body including a recessed region;
a plurality of terminals arranged in the recessed region; and
a fingerprint sensor package disposed in the recessed region,
wherein the fingerprint sensor package comprises:
a substrate including a plurality of first sensing patterns spaced apart from each other in a first direction and extending in a second direction, intersecting the first direction, and a plurality of second sensing patterns spaced apart from each other in the second direction and extending in the first direction;
a controller chip electrically connected to the substrate; and
a plurality of electrical connection structures electrically connected to the plurality of terminals and the substrate,
wherein a direction in which the plurality of electrical connection structures and the plurality of terminals face is different from a recess direction of the recessed region.

19. The device of claim 18, wherein the recessed region is formed in the shape of a hexahedron.

20. The device of claim 18, further comprising:
an encapsulant covering the controller chip and contacting the plurality of electrical connection structures; and
an anisotropic conductive film in contact with the plurality of electrical connection structures and the plurality of terminals.
